(19) United States
(12) Patent Application Publication
(10) Pub. No.: US 2010/0299845 A1
(43) Pub. Date: Dec. 2, 2010

(54) Hand Fabric Laundering Method

(76) Inventor: Daniel Victoria Lapinig, Cainta, Rizal (PH)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/475,698

(22) Filed: Jun. 1, 2009

(51) Int. Cl. C11D 3/395; C11D 3/00

(52) U.S. Cl. 8/137

(57) ABSTRACT

An improved laundering method for hand washing fabrics such as clothes, curtains, sheets, tablecloths, etc. includes the steps of providing a laundering system, adding water to a wash basin, dispersing the laundry detergent in a wash basin, adding a fabric to the wash basin, forming a wash liquor by combining the water and the laundry detergent, soaking the fabric in the wash liquor for a washing time period of from about 30 minutes to about 12 hours to form a soaked fabric, removing the soaked fabric from the wash liquor, removing wash liquor from the soaked fabric, dispersing the rinsing composition in water in a rinse basin to form a rinse solution, adding the soaked fabric to the rinse solution, soaking the soaked fabric in the rinse solution for a rinsing time period of from about 1 minute to about 1 hour to form a rinsed fabric, removing the rinsed fabric from the rinse solution, removing rinse solution from the rinsed fabric, and drying the rinsed fabric. The laundering system contains a laundry detergent and a rinsing composition. The laundry detergent is suitable for overnight soaking containing therein a bactericide and retards bacterial growth upon soaking a bacteria-contaminated fabric in a wash liquor for 6 hours at 25° C.

### FIELD OF THE INVENTION

The present invention relates to laundering s methods. Specifically, the present invention relates to hand laundering methods.

### BACKGROUND OF THE INVENTION

Hand laundering fabrics such as cloths is a tiresome and resource-intensive activity. With the typical current manual laundering procedure, about two basins of water are used; one for the pre-wetting & scrubbing prior to using the wash liquor, and then one for the actual wash liquor (especially if ordinary detergent powder is used). For the prevailing rinsing practice, three to five basins of water are consumed. Hence about five to six basins of water are used from first wetting to last rinsing.

Typically in the soaping process, laundry detergents are predissolved in a basin to form a wash liquor, and the clothes are dipped into and/or added to thereto and scrubbed by hand, with a washboard, a brush or other scrubbing device, etc. to remove soils and stains. In some cases, pretreating with specialized stain removers (e.g., bleaches, brushes, devices, etc.) is needed as well. After each piece of fabric is individually scrubbed until it is perceived to be clean, each piece of fabric is then wrung out, and put aside for rinsing. The rinsing step is also quite tiresome as large amounts of water are often required to remove soiled water, surfactants, etc. to the satisfaction of the typical hand launderer. This may require multiple rinses with clean water, which increases water costs, and significantly increases effort, especially if such water is not easily available. Slight variations of this process are possible, such as adding detergent together with the fabric, but the basic flow is essentially the same anywhere in the world where hand laundering is common. This typical process is therefore very time, labor, and resource-intensive, as it reduces the amount of time, energy, water, etc. available for other activities.

It is important to note that once clothes are wet and soaked, they take on the weight of the water absorbed. This is evident when one washes denim jeans, towels, bed sheets and covers. Manually rinsing drapes and curtains is no less as strenuous and grueling. The repeated and lengthy process of repeated dipping, pressing, scrubbing, and wringing the fabric, and replacing the water is painstaking and backbreaking. This laborious process is what makes the manual laundry an arduous weekly task for many people.

Scrubbing during the laundering process also has many other undesirable side effects as well, as fabric life is shortened due to the fabric abrasion caused when the fabric is rubbed hard against itself, a brush, a washboard, hard surface, etc. This leads to fabrics wearing out (i.e., becoming threadbare and/or developing holes) more quickly, losing their colors and becoming dull, certain fabrics may loose their sheen as the surface fibers are abraded, etc. In addition, the manual washing with certain detergents process may lead to skin problems, dryness, rashes, blisters, etc., especially in the case where harsh detergents are used, performance additives are used (e.g., chlorine bleach), and/or many fabric items are washed in quick succession without giving the hands time to recover.

While soaking laundry is well known to help reduce the need for scrubbing, in many cases with hand washing laundry detergents, soaking soiled clothes such as shirts for more than a few minutes may actually cause an increase in malodor. This is because the bacteria which is a main cause for malodor is carried on fabrics, especially shirts and socks, when they are added to the wash liquor. It has been found that many typical hand washing laundry detergents do not contain sufficient bactericide to retard bacterial growth and/or kill bacteria. Thus, soaking these fabrics in a washing liquor made with a typical hand washing detergent in fact promotes additional bacterial growth to the point where after a few hours the entire wash basin reeks of the byproducts of bacterial growth—acids and fatty acids such as isovaloric (isopentanoic) acid, urea, methylphenols, etc. If such clothes are left overnight in a wash liquor which contains insufficient enzymes and/or surfactants, then the entire wash basin and surrounding area will be quite smelly the next morning. Accordingly, it has now been found that soaking in the appropriate type of wash liquor is essential to both remove soils and also prevent malodor and/or bacterial growth.

However, soaking alone does not address the need for reduced water and effort during the rinsing stage. In contrast, rinsing products are known in the art which reduce the amount of effort and water needed for rinsing, but these in turn alone also do not address the need for reduced scrubbing.

Accordingly, the need still exists for a system and a method for comprehensively improving the hand laundering process.

### SUMMARY OF THE INVENTION

The present invention relates to an improved method for laundering a fabric using an improved laundering system. The method includes the steps of providing a laundering system, adding water to a wash basin, dispersing the laundry detergent in a wash basin, adding a fabric to the wash basin, forming a wash liquor by combining the water and the laundry detergent, soaking the fabric in the wash liquor for a washing time period of from about 30 minutes to about 12 hours to form a soaked fabric, removing the soaked fabric from the wash liquor, removing wash liquor from the soaked fabric, dispersing the rinsing composition in water in a rinse basin to form a rinse solution, adding the soaked fabric to the rinse solution, soaking the soaked fabric in the rinse solution for a rinsing time period of from about 1 minute to about 1 hour to form a rinsed fabric, removing the rinsed fabric from the rinse solution, removing rinse solution from the rinsed fabric, and drying the rinsed fabric. The laundering system contains a laundry detergent and a rinsing composition. The laundry detergent is suitable for overnight soaking containing therein a bactericide and retards bacterial growth upon soaking a bacteria-contaminated fabric in a wash liquor for 6 hours at 25° C.

It has now been found that an improved fabric laundering method can both reduce manual effort by reducing or eliminating the need for most scrubbing and reduce water use required for the normal washing and/or rinsing process. Surprisingly, this is achieved while also avoiding malodor caused by bacterial growth in the wash liquor when it is left soaking for many hours. Furthermore, the reduction in scrubbing can help to reduce fabric abrasion, leading to longer lasting clothes and clothes that look newer for a longer time. The improved fabric laundering method can also reduce or even eliminate the need for scrubbing during the laundering process, thereby reducing hand and/or skin abrasion as compared to the normal scrubbing process.

### DETAILED DESCRIPTION OF THE INVENTION

All temperatures herein are in degrees Celsius (° C.) unless otherwise indicated. As used herein, the term “comprising” means that other steps, ingredients, elements, etc. which do not adversely affect the end result can be added. This term encompasses the terms “consisting of” and “consisting essentially of”. All conditions herein are at 25° C., and atmospheric pressure unless otherwise specifically stated. Unless otherwise specifically stated, all ratios, percentages, etc. are by weight of the final composition. Unless otherwise specifically stated, the ingredients and/or equipment herein are believed to be widely available from multiple suppliers and sources around the world.

As used herein, the term “pre-wetting” means specifically adding water to a fabric prior to adding the to the wash liquor. This can be achieved by dipping, submerging, inundating, etc. the fabric with water.

The present innovation is an improved laundering method for hand washing fabrics such as clothes, curtains, sheets, tablecloths, etc. The method includes the steps of providing a laundering system, adding water to a wash basin, dispersing the laundry detergent in a wash basin, adding a fabric to the wash basin, forming a wash liquor by combining the water and the laundry detergent, soaking the fabric in the wash liquor for a washing time period of from about 30 minutes to about 12 hours to form a soaked fabric, removing the soaked fabric from the wash liquor, removing wash liquor from the soaked fabric, dispersing the rinsing composition in water in a rinse basin to form a rinse solution, adding the soaked fabric to the rinse solution, soaking the soaked fabric in the rinse solution for a rinsing time period of from about 1 minute to about 1 hour to form a rinsed fabric, removing the rinsed fabric from the rinse solution, removing rinse solution from the rinsed fabric, and drying the rinsed fabric. The laundering system contains a laundry detergent and a rinsing composition. The laundry detergent is suitable for overnight soaking containing therein a bactericide and retards bacterial growth upon soaking a bacteria-contaminated fabric in a wash liquor for 6 hours at 25° C.

The improvement in this method is the combination of a specific high performance laundry detergent and a rinsing composition to provide a holistically, comprehensively better cleaning experience which saves effort, resources, and/or money while providing excellent results. The laundry detergent is suitable for overnight soaking which means that the laundry detergent must contain sufficient bactericide to at least retard bacterial growth, as described herein. The typical laundry detergent bactericide which primarily retards bacterial growth in an extended soaking situation is selected from, for example, a bleach, an enzyme, a surfactant, and a mixture thereof, or a bleach, a surfactant and a mixture thereof, or a bleach and a mixture thereof.

The laundry detergent may include as the bactericide a bleach selected from the group consisting of a catalytic metal complex, a peroxygen source, a bleach activator, a bleach booster, a photobleach, a free radical initiator, a hypohalite bleach, and a mixture thereof, or a peroxygen source, a bleach activator, a hypohalite bleach, and a mixture thereof. Examples of suitable catalytic metal complexes include, but are not limited to, manganese-based catalysts such as Mn^{IV}₂ (u-O)₃(1,4,7-trimethyl-1,4,7-triazacyclononane)₂(PF₆)₂ disclosed in U.S. Pat. No. 5,576,282; cobalt based catalysts disclosed in U.S. Pat. No. 5,597,936 such as cobalt pentaamine acetate salts having the formula [Co(NH₃)₅OAc] T_{y}, wherein “OAc” represents an acetate moiety and “T_{y}” is an anion; transition metal complexes of a macropolycyclic rigid ligand—abbreviated as “MRL”. Suitable metals in the MRLs include Mn, Fe, Co, Ni, Cu, Cr, V, Mo, W, Pd, and Ru in their various oxidation states. Examples of suitable MRLs include: Dichloro-5,12-diethyl-1,5,8,12-tetraazabicyclo[6.6.2]hexadecane Manganese(II), Dichloro-5,12-diethyl-1,5,8,12-tetraazabicyclo[6.6.2]hexadecane Manganese(III) Hexafluorophosphate and Dichloro-5-n-butyl-12-methyl-1,5,8,12-tetraaza-bicyclo[6.6.2]hexadecane Manganese(II). Suitable transition metal MRLs are readily prepared by known procedures, such as taught for example in WO 00/332601, and U.S. Pat. No. 6,225,464.

Suitable peroxygen sources include preformed peracids, a hydrogen peroxide source in combination with a bleach activator, or a mixture thereof. Suitable preformed peracids include compounds selected from the group consisting of a percarboxylic acid and salt, a percarbonic acid and salt, a perimidic acid and salt, a peroxymonosulfuric acid and salt, and a mixture thereof. Suitable sources of hydrogen peroxide include compounds selected from the group consisting of a perborate compound, a percarbonate compound, a perphosphate compound, a persilicate compound, and a mixture thereof, or a perborate compound, a percarbonate compound, and a mixture thereof. Suitable types and levels of peroxygen sources are found in U.S. Pat. Nos. 5,576,282, 6,306,812 B1 and 6,326,348 B1 that are incorporated by reference.

Suitable bleach activators include, but are not limited to, perhydrolyzable esters and perhydrolyzable imides such as, tetraacetyl ethylene diamine, octanoylcaprolactam, benzoyloxybenzenesulphonate, nonanoyloxybenzenesulphonate, benzoylvalerolactam, dodecanoyloxybenzenesulphonate.

Suitable bleach boosters include, but are not limited to, those described U.S. Pat. No. 5,817,614.

When present, the laundry detergent typically contains from about 0.5% to about 30%, or from about 1% to about 20%, or from about 1.5% to about 10% of a bleach. Such a level is sufficient to provide the bactericide benefits herein at typical laundry detergent dilutions. As a practical matter, and not by way of limitation, the compositions and method herein can be adjusted to provide on the order of at least one part per hundred million of catalytic metal complex and/or a bleach booster in the aqueous washing.

Examples of suitable enzymes include, but are not limited to, hemicellulases, peroxidases, proteases, cellulases, xylanases, lipases, phospholipases, esterases, cutinases, pectinases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, amylases, or combinations thereof and may be of any suitable origin. The choice of enzyme(s) takes into account factors such as pH-activity, stability optima, thermostability, stability versus active detergents, chelants, builders, etc. A detersive enzyme mixture useful herein is a protease, lipase, cutinase and/or cellulase in conjunction with amylase. While detersive enzymes are described in U.S. Pat. No. 6,579,839, it is believed that bleaching enzymes, protease enzymes, cellulase enzymes, lysozyme enzymes, lipase enzymes, and amylase enzymes are particularly suited towards retarding bacterial growth.

Enzymes are normally present at up to about 5 mg, more typically from about 0.01 mg to about 3 mg by weight of active enzyme per gram of the detergent. Stated another way, the detergent herein will typically contain from about 0.001% to about 5%, or from about 0.01% to about 2%, or from about 0.05% to about 1% by weight of an enzyme, typically a commercial enzyme preparation. Protease enzymes are present at from about 0.005 to about 0.1 AU of activity per gram of detergent. Proteases useful herein include those like subtilisins from Bacillus [e.g. subtilis, lentus, licheniformis, amyloliquefaciens (BPN, BPN′), alcalophilus,] e.g. Esperase®, Alcalase®, Everlase® and Savinase® (Novozymes), BLAP and variants (Henkel). Further proteases are described in EP 130756, WO 91/06637, WO 95/10591 and WO 99/20726.

Amylases (α and/or β) are described in GB Pat. # 1 296 839, WO 94/02597 and WO 96/23873; and available as Purafect Ox Am® (Genencor), Termamyl®, Natalase®, Ban®, Fungamyl®, Duramyl® (all ex Novozymes), and RAPIDASE (International Bio-Synthetics, Inc).

The cellulase herein includes bacterial and/or fungal cellulases with a pH optimum of between 5 and 9.5. Suitable cellulases are disclosed in U.S. Pat. No. 4,435,307 to Barbesgoard, et al., issued Mar. 6, 1984. Cellulases useful herein include bacterial or fungal cellulases, e.g. produced by Humicola insolens, particularly DSM 1800, e.g. 50 kD and ^{˜}43 kD (Carezyyme®). Also suitable cellulases are the EGIII cellulases from Trichoderma longibrachiatum. WO 02/099091 by Novozymes describes an enzyme exhibiting endo-beta-glucanase activity (EC 3.2.1.4) endogenous to Bacillus sp., DSM 12648; for use in detergent and textile applications; and an anti-redeposition endo-glucanase in WO 04/053039. Kao's EP 265 832 describes alkaline cellulase K, CMCase I and CMCase II isolated from a culture product of Bacillus sp KSM-635. Kao further describes in EP 1 350 843 (KSM S237; 1139; KSM 64; KSM N131), EP 265 832A (KSM 635, FERM BP 1485) and EP 0 271 044 A (KSM 534, FERM BP 1508; KSM 539, FERM BP 1509; KSM 577, FERM BP 1510; KSM 521, FERM BP 1507; KSM 580, FERM BP 1511; KSM 588, FERM BP 1513; KSM 597, FERM BP 1514; KSM 522, FERM BP 1512; KSM 3445, FERM BP 1506; KSM 425. FERM BP 1505) readily-mass producible and high activity alkaline cellulases/endo-glucanases for an alkaline environment. Such endo-glucanase may contain a polypeptide (or variant thereof) endogenous to one of the above Bacillus species. Other suitable cellulases are Family 44 Glycosyl Hydrolase enzymes exhibiting endo-beta-1,4-glucanase activity from Paenibacilus polyxyma (wild-type) such as XYG1006 described in WO 01/062903 or variants thereof. Carbohydrases useful herein include e.g. mannanase (see, e.g., U.S. Pat. No. 6,060,299), pectate lyase (see, e.g., WO 99/27083), cyclomaltodextrin glucanotransferase (see, e.g., WO96/33267), and/or xyloglucanase (see, e.g., WO 99/02663). Bleaching enzymes useful herein with enhancers include e.g. peroxidases, laccases, oxygenases, lipoxygenase (see, e.g., WO 95/26393), and/or (non-heme) haloperoxidases.

Suitable endoglucanases include: 1) An enzyme exhibiting endo-beta-1,4-glucanase activity (E.C. 3.2.1.4), with a sequence at least 90%, or at least 94%, or at least 97% or at least 99%, or 100% identity to the amino acid sequence of positions 1-773 of SEQ ID NO:2 in WO 02/099091; or a fragment thereof that has endo-beta-1,4-glucanase activity. GAP in the GCG program determines identity using a GAP creation penalty of 3.0 and GAP extension penalty of 0.1. See WO 02/099091 by Novozymes A/S on Dec. 12, 2002, e.g., Celluclean™ by Novozymes A/S. GCG refers to sequence analysis software package (Accelrys, San Diego, Calif., USA). GCG includes a program called GAP which uses the Needleman and Wunsch algorithm to find the alignment of two complete sequences that maximizes the number of matches and minimizes the number of gaps; and 2) Alkaline endoglucanase enzymes described in EP 1 350 843A published by Kao on Oct. 8, 2003 ([0011]-[0039] and examples 1-4).

Suitable lipases include those produced by Pseudomonas and Chromobacter, and LIPOLASE®, LIPOLASE ULTRA®, LIPOPRIME® and LIPEX® from Novozymes. See also Japanese Patent Application 53-20487, laid open on Feb. 24, 1978, available from Areario Pharmaceutical Co. Ltd., Nagoya, Japan, under the trade name Lipase P “Amano.” Other commercial lipases include Amano-CES, lipases ex Chromobacter viscosum, available from Toyo Jozo Co., Tagata, Japan; and Chromobacter viscosum lipases from U.S. Biochemical Corp., U.S.A. and Diosynth Co., The Netherlands, and lipases ex Pseudomonas gladioli. Also suitable are cutinases [EC 3.1.1.50] and esterases.

If an enzyme is included herein, an enzyme stabilization system may also be present. Such systems are well-known in the art, and to the artisan.

The surfactant useful herein typically is selected from an anionic surfactant, a nonionic surfactant, a cationic surfactant, a zwitterionic surfactant, an ampholytic surfactant, a semi-polar nonionic surfactant, a gemini surfactant, and a mixture thereof; or an anionic surfactant, a nonionic surfactant, a zwitterionic surfactant, and a mixture thereof; or an anionic surfactant, a nonionic surfactant, and a mixture thereof. The surfactant is typically present at from about 1% to about 80%, or from about 5% to about 50%, or from about 10% to about 35%.

The anionic surfactant useful herein has an alkyl chain length of from about 6 carbon atoms (C₆), to about 22 carbon atoms (C₂₂), and are well-known in the art of detergent formulations. Nonlimiting examples of anionic surfactants useful herein include:
a) linear alkyl benzene sulfonates (LAS), especially C₁₁-C₁₈ LAS;
b) primary, branched-chain and random alkyl sulfates (AS), especially C₁₀-C₂₀ AS;
c) secondary (2,3) alkyl sulfates having formulas (I) and (II), especially C₁₀-C₁₈ secondary alkyl sulfates:

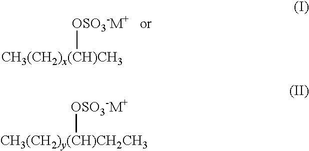

M in formulas (I) and (II) is hydrogen or a cation which provides charge neutrality. For the purposes herein, all M units, whether associated with a surfactant or adjunct ingredient, can either be a hydrogen atom or a cation depending upon the form isolated by the artisan or the relative pH of the system wherein the compound is used. Non-limiting examples of preferred cations include sodium, potassium, ammonium, and mixtures thereof. Wherein x is an integer of at least about 7, or at least about 9; and y is an integer of at least 8, or at least about 9;
d) alkyl alkoxy sulfates (AEₓS), especially C₁₀-C₁₈ AEₓS wherein x is from about 1 to about 30, or from about 2 to about 10;
e) alkyl alkoxy carboxylates, especially C₆-C₁₈ alkyl alkoxy carboxylates, preferably comprising about 1-5 ethoxy units;
f) mid-chain branched alkyl sulfates as discussed in U.S. Pat. No. 6,020,303 to Cripe, et al., granted on Feb. 1, 2000; and U.S. Pat. No. 6,060,443 to Cripe, et al., granted on May 9, 2000;
g) mid-chain branched alkyl alkoxy sulfates as discussed in U.S. Pat. No. 6,008,181 to Cripe, et al., granted on Dec. 28, 1999; and U.S. Pat. No. 6,020,303 to Cripe, et al., granted on Feb. 1, 2000;
h) methyl ester sulfonate (MES); and
i) primary, branched chain and random alkyl or alkenyl carboxylates, especially those having from about 6 to about 18 carbon atoms.

Generally, the present invention contains from about 0.1% to about 25%, or from about 0.5% to about 20%, or from about 1% to about 17% by weight of the final composition of a nonionic surfactant. Non-limiting examples of nonionic surfactants include:
a) C₁₂-C₁₈ alkyl ethoxylates, such as, the NEODOL® nonionic surfactants from Shell Corp.;
b) C₆-C₁₂ alkyl phenol alkoxylates wherein the alkoxylate units are a mixture of ethyleneoxy and propyleneoxy units;
c) C₁₂-C₁₈ alcohol and C₆-C₁₂ alkyl phenol condensates with ethylene oxide/propylene oxide block polymers such as Pluronic® from BASF Aktiengesellschaft;
d) C₁₄-C₂₂ mid-chain branched alcohols (BA) as discussed in U.S. Pat. No. 6,150,322 to Singleton, et al., granted on Nov. 21, 2000;
e) C₁₄-C₂₂ mid-chain branched alkyl alkoxylates (BAEₓ) where x is from about 1-30, as discussed in U.S. Pat. No. 6,153,577 to Cripe, et al., granted on Nov. 28, 2000; U.S. Pat. No. 6,020,303 to Cripe, et al., granted on Feb. 1, 2000; and U.S. Pat. No. 6,093,856 to Cripe, et al., granted on Jul. 25, 2000;
f) polyhydroxy fatty acid amides as discussed in U.S. Pat. No. 5,332,528 to Pan and Gosselink, granted on Jul. 26, 1994; PCT Publication WO 92/06162 A1 to Murch, et al., published on Apr. 16, 1992; PCT Publication WO 93/19146 A1 to Fu, et al., published on Sep. 30, 1993; PCT Publication WO 93/19038 A1 to Conner, et al., published on Sep. 30, 1993; and PCT Publication WO 94/09099 A1 to Blake, et al., published on Apr. 28, 1994;
g) ether-capped poly(oxyalkylated) alcohol surfactants as discussed in U.S. Pat. No. 6,482,994 to Scheper and Sivik, granted on Nov. 19, 2002; and PCT Publication WO 01/42408 A2 to Sivik, et al., published on Jun. 14, 2001.

Non-limiting examples of a cationic surfactant includes: the quaternary ammonium surfactants, which can have up to 26 carbon atoms. If present, the cationic surfactant is typically from about 0.75% to about 5% by weight.
a) alkoxylate quaternary ammonium (AQA) surfactants as discussed in U.S. Pat. No. 6,136,769;
b) dimethyl hydroxyethyl quaternary ammonium as discussed in U.S. Pat. No. 6,004,922;
c) polyamine cationic surfactants as discussed in WO 98/35002, WO 98/35003, WO 98/35004, WO 98/35005, and WO 98/35006;
d) cationic ester surfactants as discussed in U.S. Pat. Nos. 4,228,042, 4,239,660 4,260,529 and U.S. Pat. No. 6,022,844; and
e) amino surfactants as discussed in U.S. Pat. No. 6,221,825 and WO 00/47708, specifically amido propyldimethyl amine.

Non-limiting examples of a zwitterionic surfactant includes: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylamino-1-propane sulfonate where the alkyl group can be C₈ to C₁₈, preferably C₁₀ to C₁₄.

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. Typically, one of the aliphatic substituents contains at least about 8 carbon atoms, typically from about 8 to about 18 carbon atoms, and at least one contains an anionic water-solubilizing group, e.g. carboxy, sulfonate, sulfate, etc. See, e.g., U.S. Pat. No. 3,929,678 to Laughlin, et al., issued Dec. 30, 1975 at column 19, lines 18-35, for examples of ampholytic surfactants.

Non-limiting examples of semi-polar nonionic surfactants include: water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms. See WO 01/32816; U.S. Pat. No. 4,681,704; and U.S. Pat. No. 4,133,779.

Gemini Surfactants are compounds having at least two hydrophobic groups and at least two hydrophilic groups per molecule have been introduced. These have become known as “gemini surfactants” in the literature, e.g., Chemtech, March 1993, pp. 30-33, and J. Am. Chem. Soc., 115, 10083-90 (1993) and the references cited therein.

These surfactants are typically commodities that are readily-available from a variety of suppliers around the world, in any quantity and quality desired.

It is essential that the laundry detergent retards bacterial growth upon soaking in a wash liquor thereof, with a fabric contaminated with bacteria, for 6 hours at 25° C. as per the test described herein. This is to ensure that malodor is not generated during the soaking process in the wash liquor.

Rinsing compositions are well-known in the art and typically include laundry sours, rinse aids, laundry rinses, etc. Rinsing compositions typically contain ingredients specifically directed towards reducing surfactant residue, collapsing suds, neutralizing alkaline pH left over from the laundry detergent, etc. It is important to note that fabric conditioners and fabric softeners which do not have a suds suppression or collapsing function are not included in the scope of the rinsing compositions herein, as they would not provide the water and effort savings benefits critical to the laundering system herein. Thus the rinsing composition typically contains a suds suppressing system present at a level of from 0.01% to 15%, or from 0.1% to 5% by weight of the rinsing composition. Suitable suds suppressing systems for use herein include any known antifoam compound, including silicone antifoam compounds and 2-alkyl alcanol antifoam compounds. Useful silicone antifoam compounds are the siloxanes, particularly the polydimethylsiloxanes having trimethylsilyl end blocking units. Other suitable antifoam compounds include the monocarboxylic fatty acids and soluble salts thereof, which are described in U.S. Pat. No. 2,954,347. A preferred particulate suds suppressing system is described in EP Patent Publication No. 210 731 A and EP Patent Publication No. 210 721 A, both to Dow Corning.

Examples of some non-limiting rinsing compositions useful herein are described in, for example, U.S. Pat. No. 4,828,750 to Simion, et al., published on May 9, 1989; WO 02/72745 to DeMeyere, et al., published on Sep. 19, 2002; WO 06/113658 to Frankenbach, et al., published on Oct. 26, 2006; WO 01/98447 A3 to Price, et al., published Dec. 27, 2001; WO 03/016447 to DeMeyere, published on Feb. 27, 2003; WO 03/097781 to Bettiol, et al., published on Nov. 27, 2003; WO 03/097776 to Bettiol, et al., published on Nov. 27, 2003; WO 01/21747 to Bettiol, et al., published on Mar. 29, 2001.

The rinsing composition may further contain an anionic surfactant scavenger, such as a cationic or zwitterionic moiety which scavenges anionic surfactants from the fabric, the rinsing solution, etc. Certain water-soluble cationic moieties such as cationic molecules, zwitterionic molecules, betaines, etc. may perform this function. In some cases, such an anionic surfactant scavenger may form a coacervate with the anionic surfactant in order to remove it from the fabric and/or rinse solution. See, for example, the cationic polymers detailed in U.S. Pat. No. 6,492,322 to Cooper, et al., granted on Dec. 10, 2002.

The rinsing composition may also provide additional benefits, such as softening, fabric maintenance, perfume, etc. In an embodiment herein, the rinsing composition also provides a fabric conditioning benefit, such as softness. In an embodiment herein, the rinsing composition contains a fabric softening active, such as a silicone-based and/or quaternary ammonium-based softening active. Such compounds and formulas are well-known in the art.

The laundry detergent and/or rinsing composition herein may contain additional adjunct ingredients known in the art such as a builder, a chelant, a dye transfer inhibitor, a dye, a perfume, and a mixture thereof. In most cases, both the laundry detergent and the rinsing composition will contain one or more perfumes therein.

The laundry detergent will typically comprise at least about 1% builder, preferably from about 5%, more preferably from about 10% to about 80%, preferably to about 50%, more preferably to about 30% by weight, of detergent builder. Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

The laundry detergent may contain a chelant therein as well. The chelant controls the adverse effects of heavy metal contamination or water hardness (for example, calcium and magnesium ions) in an aqueous bath by binding with metal ions. Any ligand with multidentate is suitable as a chelating agent. For example, suitable chelating agents can include, but are not limited to, carboxylates, phosphates, phosphonates, polyfunctionally-substituted aromatic compounds, polyamines, biodegradable compounds, the alkali metal, ammonium or substituted ammonium salts or complexes of these chelating agents, and mixtures thereof. Further examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876. If present, the chelant typically is from about 0.01% to about 10%, or from about 0.1% to about 5% by weight of the laundry detergent.

Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the cleaning compositions herein, the dye transfer inhibiting agents are present at levels from about 0.0001% to about 10%, or about 0.01% to about 2% by weight.

In an embodiment herein, the laundering detergent and the rinsing composition are sold together as a laundering kit. In an embodiment herein, the laundering kit contains a predetermined number of laundry detergent doses and a predetermined number of rinsing composition doses. In such a case, the predetermined number of laundry detergent doses often equals the predetermined number of rinsing composition doses, so as to promote system usage. However, in other cases, it is recognized that sometimes the predetermined number of laundry detergent doses may be greater than the predetermined number of rinsing composition doses, so as to wash, for example, highly soiled clothes.

### Bacteria Measurement Method

The bacterial growth can easily be gauged by smelling the wash liquor and/or the fabrics after the soaking step. One skilled in the art will understand that if the fabric and/or the wash liquor smells stinky (e.g., like a locker room, old sweaty socks, mold, or bad body odor) to the typical human nose, then there has been an increase in bacteria and thus the bacterial growth has not been retarded as the word is used herein. However, if there is little or no malodor, as detectable to the normal human nose, after the soaking step, the it is assumed that the bacterial growth has been retarded as the word is used herein. While this test may seem a bit subjective, it is actually pretty accurate and sufficient for a rough judgment. More specific methods for measuring bacteria are of course known in the art and typically employ titers of bacteria and then growing the diluted bacteria on agar plates. While these take time and effort, they are standard in the art, and can be conducted in most high school or university biology laboratories. After incubation, colonies are counted, and extrapolated to estimate the total amount of bacteria in the sample and/or the system. In the present case, any such method is sufficient, as long as the agar supports the type of bacteria which produces malodor, and as long as the incubation time is at least 6 hours at 25° C.

The base bacteria count is the number of bacteria present on a fabric before the fabric is laundered. Initially, a base bacteria count is taken by directly sampling a contaminated fabric, such as, for example, a sweaty shirt, before it is added to the wash liquor. The sample should be taken from the most contaminated part, such as the armpit area. The bacteria sample is separated from the fabric by methods known in the art, and the total bacteria on the shirt is extrapolated and/or calculated. For such a measurement, it is assumed that the bacteria on other portions of the shirt is negligible in comparison to the portion from the armpit, and so for a rough measurement, such bacteria from other locations may be ignored. However, in cases where more exact measurements are required, known staining techniques can easily tell the concentrations and locations of bacteria on a shirt, and such a measurement can establish the base bacteria count.

Alternatively, the contaminated fabric may be “dosed” with a known number of bacteria from a known culture before laundering. In such a case, the amount of bacteria does should approximate what is found on actual laundry, and would represent the base bacteria count.

After incubation, the wash liquor is sampled, titrated as needed, and the bacteria counted (with further incubation if necessary) to establish the incubated bacteria count, which is defined herein as the number of bacteria in the total volume of wash liquor after the fabric has been soaking in it for 6 hours at 25° C.

The laundry detergent should retard the growth of bacteria in the wash liquor so as to reduce or avoid malodor. Thus, “retards bacterial growth” means that after 6 hours soaking at 25° C., the incubated bacteria count with the wash liquor of the present invention should be less than with a comparable system where the fabric is soaked in water (no laundry detergent) for the same amount of time and under the same conditions. Typically this is measured by smelling the fabric and the wash liquor as described above. In an embodiment herein, the incubated bacteria count in the wash liquor upon soaking for 6 hours at 25° C. is less than or equal to 10 times the base bacteria count, or less than or equal to the base bacteria count. One skilled in the art understands that the lowest possible incubated bacteria count is 0, or below the detection threshold, which would indicate substantially all the bacteria is killed in the wash liquor and therefore assumedly on the fabric. In an embodiment herein, the retarding of bacterial growth is evidenced by a lack of malodor, as detectable by the human nose.

### Method of Use

The laundry detergent methods and use of the laundry detergent system are conducted at the typical dosages and/or dilutions recommended by the manufacturer. The present innovation also includes a method of hand laundering a fabric by employing the laundering system described herein, adding water to a wash basin, dispersing the laundry detergent in a wash basin, adding a fabric to the wash basin, forming a wash liquor by combining the water and the laundry detergent, soaking the fabric in the wash liquor for a washing time period of from about 30 minutes to about 12 hours to form a soaked fabric, removing the soaked fabric from the wash liquor, removing wash liquor from the soaked fabric, dispersing the rinsing composition in water a rinse basin to form a rinse solution, adding the soaked fabric to the rinse solution, soaking the soaked fabric in the rinse solution for a rinsing time period of from about 1 minute to about 1 hour to form a rinsed fabric, removing the rinsed fabric from the rinse solution, removing rinse solution from the rinsed fabric, and drying the rinsed fabric. One skilled in the art will understand that many variations of this basic process are possible, as for example, when the water is added to the wash basin either before or after the laundry detergent and/or the fabric; where the wash basin and the rinse basin are the same basin, etc.

The laundry detergents herein are especially well-suited for use in a hand-washing context and in hard water conditions where the water hardness is between about 10 ppm to about 600 ppm; or from about 15 ppm to about 340 ppm; or from about 17 ppm to about 300 ppm, or from about 20 ppm to about 230 ppm of hard water ions such as Ca²⁺, Mg²⁺, etc., or such as Ca²⁺ and/or Mg²⁺. For hand-washing, the laundry detergent is typically diluted with water by a factor of from about 1:150 to about 1:1000, or about 1:200 to about 1:500 by weight, by placing the laundry detergent in a container along with wash water to form a wash liquor. The rinsing composition is typically diluted from about 1 to about 10000 times, or from about 10 to about 5000, or from about 300 to about 600 times in a basin for hand-rinsing.

The wash and/or rinse basin is typically square, rectangular, oval or round and is wider than it is deep. The water used to form the wash liquor and/or the rinse solution is typically whatever water is easily available, such as tap water, river water, well water, etc. The temperature of the water may range from about 2° C. to about 50° C., or from about 5° C. to about 40° C., or from 10° C. to 40° C., although higher temperatures may be used for soaking and/or pretreating.

In a particular embodiment herein, the wash liquor and/or the rinse solution are removed from the soaked fabric by wringing. In an embodiment herein, the method further includes the step of agitating the rinse solution by, for example, dipping the fabric (i.e., raising the fabric out and then lowering it) into the rinse solution one or more times. In an embodiment herein, the fabric may be dipped into the wash solution as well—however, one skilled in the art realizes that such dipping does not constitute scrubbing the fabric in any way. In an embodiment herein, the fabric comprises a soil, and the soaked fabric is not scrubbed to remove the soil.

Even though the typical current hand-washing practice is to pre-wet the fabric before adding it to the wash liquor, in another embodiment herein, the fabric is added to the wash basin without any pre-wetting. This means that the fabric is substantially dry, without any purposely-added water thereupon, although it is recognized that some water or moisture may be present in the fabric from, for example sweat, soils, etc. Without intending to be limited by theory, it is believed that this is especially surprising and advantageous, as this ensures that the wash liquor, including the bactericide, is better absorbed into the fabric from the beginning. This may improve the ability of the surfactant to get to the soils, and remove them from the fabric during the soaking period. In an embodiment herein, the soaked fabric is not scrubbed to remove the soil thereby prolonging fabric life by reducing fabric abrasion. In an embodiment herein, the laundering system contains a laundering kit, wherein the laundering detergent and the rinsing composition are sold together, and the laundering kit comprises a predetermined number of laundry detergent doses and a predetermined number of rinsing composition doses.

In an embodiment herein, the drying step comprises hanging the rinsed fabric, and typically the rinsed fabric will he hung on a clothesline outside, and often in the sunlight.

In an embodiment herein, the washing time period is from about 1 hour to about 10 hours, or from about 2 hours to about 8 hours, or from about 4 hours to about 7 hours. In an embodiment herein, the wash liquor becomes clear during the washing time period. In such cases the dirt and other particulates may settle to the bottom of the wash basin as sediment. In an embodiment herein, the rinsing time period is from about 2 minutes to about 30 minutes, or from about 3 minutes to about 20 minutes, or from about 4 minutes to about 10 minutes. In an embodiment herein, the soaked fabric is soaked in the rinse solution once, and no additional rinsing step with water is conducted. Such a method maximizes the water savings herein.

The laundry detergent and/or the rinsing composition are independently in any known convenient form, such as a powder, a gel, a liquid, or a solid (i.e., a cube). In an embodiment herein, the laundry detergent is in a powdered and/or granular form, while the rinsing composition is in a liquid form.

### EXAMPLE 1

A commercially-available laundry detergent (Ariel sold in the Philippines) containing 2.6% bleach (perborate+nonanoyloxybenzenesulphonate), 0.3% active enzyme (protease, cellulase mixture), and 21% LAS surfactant in addition to conventional builders, chelants, pH buffers, etc. is predissolved in a wash basin at a laundry detergent:water weight ratio of 1:250. The room-temperature (about 25° C.) water is added first, and then the laundry detergent is dispersed therein, with mild stirring by hand to disperse the laundry detergent and form a turbid wash liquor. A typical load of laundry (about 5 kg of denim pants, t-shirts, underwear, etc.) were combined and added into the wash liquor, including a sweaty t-shirt from exercising. The wash liquor was left to soak overnight for 6 hours. While the denim pants and t-shirt are dipped in the wash liquor 2-3 times, no actual scrubbing is conducted.

After about 4 hours, the wash liquor became clear with some sediment at the bottom. No malodor is detected by the human nose after 6 hours soaking. The soaked fabric is removed from the wash liquor and wrung out via hand to remove excess washing liquor.

A rinse solution is prepared by diluting with water a rinsing composition (Downy 1Banlaw, commercially available in the Philippines) containing 0.3% silicone suds suppressor, 5% fabric softening active, and other conventional fabric softener ingredients. 33 mL of rinsing composition is added to 15 L of water to form the rinse solution. The wrung-out soaked fabrics are added to the rinse solution, dipped 2 times, and soaked for 5 minutes to form rinsed fabric. The rinsed fabric is then removed from the rinse solution and wrung out. The fabrics smell clean and fresh with no noticeable malodor. The rinsed fabrics are then hung up to dry on a conventional clothesline in the sunlight. The fabrics show reduced abrasion, no detectable malodor, and are clean with all of the visible soils removed. The person washing the fabrics has little or no washing-related skin abrasion on her hands.

A total of 2 basins of water are used—1 for the wash liquor, and 1 for the rinse liquor.

### EXAMPLE 2

In a comparative example, the process according to Example 1 is followed, except that a detergent composition (a granular detergent commercially-available in the Philippines) which contains surfactant, but lacks bleach is used at a similar concentration. After 6 hours of soaking in the wash liquor, an easily noticeable malodor is evident in the wash liquor and the fabrics. In addition, after soaking the denim pants are still dirty and require additional scrubbing to remove dirt.

After drying the fabrics still have a noticeable malodor, although it is less than after initial soaking in the wash liquor. Due to the additional scrubbing needed, the person washing the fabrics has noticeable washing-related skin abrasion on her hands which are red after scrubbing.

### EXAMPLE 3

The process according to Example 1 is followed, except that the fabrics are rinsed in regular water twice per the local custom, and a fabric conditioner is added in a 3^{rd} rinse. Due to the multiple rinsing steps, the fabrics must be wrung 2 more times than in Example 1. The fabrics have no detectable malodor, and are clean with all of the visible soils removed. A total of 4 basins of water are used—1 for the wash liquor, and 3 for the rinsing steps.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of hand laundering a fabric comprising the steps of:
A. providing a laundering system comprising:
i. a laundry detergent suitable for overnight soaking comprising a bactericide, which comprises a bleach, an enzyme, and an anionic surfactant, wherein the laundry detergent is free of a quaternary ammonium-based fabric softening active and wherein the laundry detergent retards bacterial growth upon soaking in a wash liquor thereof with a fabric contaminated with bacteria; and
ii. a rinsing composition, which comprises a quaternary ammonium-based fabric softening active and a suds suppressing system, wherein the rinsing composition is free of anionic surfactant;
B. adding water to a wash basin;
C. dispersing the laundry detergent in a wash basin;
D. adding a fabric to the wash basin;
E. forming a wash liquor by combining the water and the laundry detergent;
F. soaking the fabric in the wash liquor for a washing time period of from about 2 hours to about 8 hours to form a soaked fabric;
G. removing the soaked fabric from the wash liquor;
H. removing wash liquor from the soaked fabric;
I. dispersing the rinsing composition in water in a rinse basin to form a rinse solution;
J. adding the soaked fabric to the rinse solution;
K. soaking the soaked fabric in the rinse solution for a rinsing time period of from about 1 minute to about 1 hour to form a rinsed fabric;
L. removing the rinsed fabric from the rinse solution;
M. removing rinse solution from the rinsed fabric; and
N. drying the rinsed fabric.

2. (canceled)

3. The method according to claim 1, wherein the wash liquor is removed from the soaked fabric by wringing.

4. The method according to claim 1, wherein the rinse solution is removed from the rinsed fabric by wringing.

5. The method according to claim 1, wherein the fabric is added to the wash basin without pre-wetting.

6. The method according to claim 1, comprising the step of agitating the rinse solution.

7. The method according to claim 1, wherein the fabric comprises a soil, and wherein the soaked fabric is not scrubbed to remove the soil.

8. The method according to claim 1, wherein the drying step comprises hanging the rinsed fabric.

9. (canceled)

10. The method according to claim 1, wherein the rinsing time period is from about 2 minutes to about 30 minutes.

11. The method according to claim 1, wherein the soaked fabric is not scrubbed to remove the soil thereby prolonging fabric life by reducing fabric abrasion.

12. The method according to claim 1, wherein the soaked fabric is not scrubbed to remove the soil thereby reducing skin abrasion on hands as compared to a regular hand washing method requiring scrubbing.

13. The method according to claim 1, wherein the laundering system comprises a laundering kit, wherein the laundering detergent and the rinsing composition are sold together, and wherein the laundering kit comprises a predetermined number of laundry detergent doses and a predetermined number of rinsing composition doses.

14. The method according to claim 1, wherein the soaked fabric is soaked in the rinse solution once, and wherein no additional rinsing step with water is conducted.

15. (canceled)

16. (canceled)

17. The method according to claim 10, wherein the rinsing time period is from about 3 minutes to about 20 minutes.

18. The method according to claim 1, wherein the washing time period is from about 4 hours to about 7 hours.

19. The method according to claim 17, wherein the rinsing time period is from about 4 minutes to about 10 minutes.

20. The method according to claim 1, wherein the rinsing composition further comprises an anionic surfactant scavenger.
